(19) United States
(12) Patent Application Publication
(10) Pub. No.: US 2008/0208402 A1
(43) Pub. Date: Aug. 28, 2008

(54) PROCESSOR HEALTH CHECK UTILIZING INTELLIGENT PERIPHERAL

(76) Inventors: Shashikant G. Vhasure, Canton, MI (US); Gary P. Miller, Canton, MI (US)

Correspondence Address: VISTEON/BRINKS HOFER GILSON & LIONE, 524 South Main Street, Suite 200, Ann Arbor, MI, 48104, US

(21) Appl. No.: 11/678,237

(22) Filed: Feb. 23, 2007

(51) Int. Cl. B60L 3/08

(52) U.S. Cl. 701/22

(57) ABSTRACT

An electronic safety monitor system includes a processor having a main processor and a quizzer unit. The main processor is in communication with the quizzer unit and includes control software and independent plausibility check software. The control software configures the main processor to output a control signal corresponding to a driver demand input signal. The independent plausibility check software configures the main processor to output an enable signal when the control signal correctly corresponds to the driver demand input signal. The quizzer unit is configured to determine if the main processor is correctly executing the control software and the independent plausibility checker software.

### BACKGROUND

1. Field of the Invention

The present invention relates to electronic safety monitor systems and more specifically electronic safety monitor systems for automobiles.

2. Description of Related Art

In the past, a driver of an automobile would interact with the automobile via a series of mechanical inputs in communication with mechanical and/or hydraulic systems. For example, if the driver desired the automobile to accelerate, the driver would engage an accelerator pedal causing the automobile to accelerate. When the driver presses the accelerator pedal, a series of mechanical and/or hydraulic systems would transfer the input from the driver to an engine throttle.

With the advent of drive-by-wire engine, steering and brake control systems, input from a driver is communicated to these drive-by-wire systems via an electronic signal. For example, when the driver presses on the accelerator pedal, an electronic system will measure the amount the pedal is depressed and send an electrical signal to the engine control computer. From there, the engine control computer sends a signal to actuate the engine throttle.

It is of great concern that these drive-by-wire systems are actuated such that the actuation corresponds to the input from the driver. For example, if the driver wishes to slowly accelerate the automobile, the driver of the automobile slightly presses on the accelerator pedal which sends an appropriate signal to the engine control computer. If the engine control computer outputs a signal to actuate the engine throttle that does not correspond with the input from the driver, an unsafe driving situation could occur.

In order to minimize the occurrence of such a situation, numerous safety systems and backup systems have been developed to determine if the signals provided to the engine, braking and steering systems correspond to the input from the driver. For example, as shown in U.S. Pat. No. 6,490,511 to Raftari, et al., a main controller circuit determines the input from the driver. A quizzer unit, is separate from main controller circuit, verifies that the main controller circuit is operating properly. Typically, main controller circuit and quizzer units are spread across a series of several semiconductor circuits. Multiple semiconductor circuits are utilized in order to avoid any common mode errors that may manifest if the primary and backup systems are located on a single semiconductor circuit. However, although this system is effective, the use of multiple semiconductor circuits is costly and something to avoid. Therefore, there is a need for a more cost effective electronic safety monitor system.

### SUMMARY

In satisfying the above need, as well as overcoming the enumerated drawbacks and other limitations of the related art, the present invention provides an electronic safety monitor system having a processor. The processor includes both a main processor and a quizzer unit. The main processor is in communication with the quizzer unit and also includes control software and independent plausibility check software. The control software configures the main processor to output a control signal corresponding to a driver demand input signal. The independent plausibility check software configures the main processor to output an enable signal when the control signal correctly corresponds to the driver demand input signal. The quizzer unit is configured to determine if the main processor is correctly executing the control software and the independent plausibility checker software.

The main processor may be further configured by the independent plausibility check software to output a main processor signal when the control signal correctly corresponds to the driver demand input signal. Additionally, the quizzer unit may be configured to output a quizzer unit signal when the main processor is correctly executing the control software and the independent plausibility checker software. Finally, a monitor circuit separate from the processor, may be in communication with the main processor and quizzer unit and configured to output a monitor disable signal if the monitor does not receive the main processor signal or the quizzer unit signal.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is an electronic safety monitor system embodying the principles of the present invention; and

FIG. 2 is an electronic safety monitor system having a monitor circuit embodying the principles of the present invention.

### DETAILED DESCRIPTION

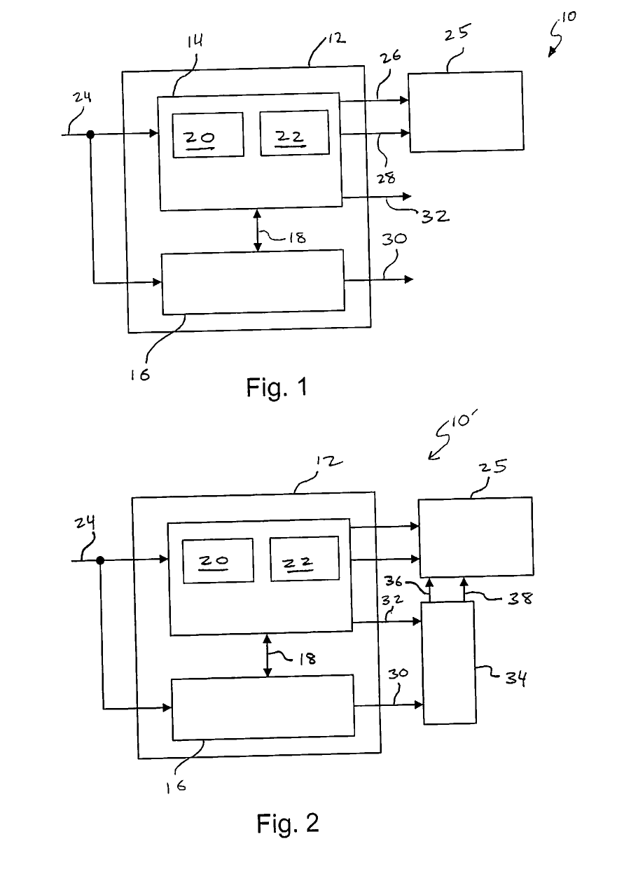

Referring to FIG. 1, an electronic safety monitor system 10 is shown. The electronic safety monitor system 10 includes a processor 12 having a main processor 14 and a quizzer unit 16. The quizzer unit 16 may be a coprocessor, a stacked die or an intelligent peripheral, such as those found on PowerPC microprocessors manufactured by Freescale Semiconductor, Inc., of Austin, Tex. The quizzer unit 16 and the main processor 14 are in communication with each other as indicated by arrow 18.

The main processor 14 includes control software 20 and independent plausibility check (IPC) software 22. As will be later described, the main control software 20 and the IPC software 22 contain instructions executed by the main processor 14. These instructions configure the main processor 14 to perform a series of functions as will be outlined below.

The main processor 14 is configured to receive a driver demand signal 24. The driver demand signal 24 may be any drive-by-wire signal including, but not limited to a throttle-by-wire demand signal, a brake-by-wire demand signal or a steer-by-wire demand signal. A throttle-by-wire demand signal is a signal indicating the amount of output an engine should produce; a brake-by-wire demand signal is a signal indicating the braking force the brakes of an automobile should apply; a steer-by-wire demand signal is a signal indicating the amount the steering system should be actuated.

The main control software 20 configures the processor to receive the driver demand signal 24 and output a control signal 26. The control signal 26 is a signal that instructs a system 25 to function in a specific manner. The system 25 may be an engine, braking or steering unit.

The IPC software 22 configures the main processor 14 to determine if the control signal 26 properly corresponds to the driver demand signal 24. When the control signal 26 properly corresponds to the demand signal 24, the main processor 14 outputs an enable signal 28 to the system 25. Conversely, if the main processor 14 determines that the control signal 26 does not correspond to the driver demand signal 24, the enable signal 28 will not be outputted to the system 25. By not outputting an enable signal 28, the system 25 will be disabled or placed in a safe mode of operation where backup systems are triggered.

As stated previously, the quizzer unit 16 is located within the processor 12. The quizzer unit 16 is configured to evaluate the main processor 14 and determine if the main processor 14 is operating correctly. More specifically, the quizzer unit 16 performs a series of tests on the main processor 14 in order to determine if the main processor 14 is properly executing the main control software 20 and the IPC software 22. These tests include an instruction set test, a program flow task monitoring test, a program flow order monitoring test and a RAM/ROM check.

If the quizzer unit 16 determines that the main processor 14 is properly executing the main control software 20 and the IPC software 22, the quizzer unit 16 outputs a quizzer unit signal 30. Generally, the quizzer unit signal 30 is a toggled signal. For example, the quizzer unit 16 will periodically monitor the main processor 14. Every time the quizzer unit 16 determines that the main processor 14 is properly executing the main control software 20 and the IPC software 22, the quizzer unit 16 will toggle the output of the quizzer unit signal 30 between a high state and a low state. Alternatively, the quizzer unit signal 30 may be an analog signal or a digital signal. For example, the analog signal may be an analog output of a certain frequency. The digital signal may be a digital high signal that is only sent by the quizzer unit 16 unless the quizzer unit 16 determines that the main control software 20 or the IPC software 22 is not properly being executed by the main processor 14.

The IPC software 22 also configures the main processor 14 to perform a series of tests on the quizzer unit 16. If the main processor 14 determines that the quizzer unit 16 is properly functioning, the main processor 14 will output a main processor signal 32. The main processor signal 32 may be similar to the quizzer unit signal 30 in that the main processor signal 32 may be a toggled signal, an analog signal or a digital signal.

Referring to FIG. 2, another embodiment of the electronic safety monitor system 10′ is shown. The electronic safety monitor system 10′ of this embodiment is similar to the electronic safety system 10 of FIG. 1; however, a monitor circuit 34 is in communication with the quizzer unit signal 30 and the main processor signal 32. In all other regards, the system 10′ operates as previously discussed. Attention is therefore directed to those prior paragraphs of this document for details thereon.

Manufacturing a single silicon die containing both the main processor 14 and the quizzer unit 16 as part of a single processor 12 is highly cost effective. However, manufacturing both the quizzer unit 16 and the main processor 14 as part of the same die may allow common mode errors to manifest themselves in both the quizzer unit 16 and the main processor 14. Here, both the main processor 14 and the quizzer unit 16 share the same clock, power supply and memory. Any error in the clock circuitry, power supply or memory affects both the main processor 14 and the quizzer unit 16. These common mode errors if not detected could potentially lead to unmitigated power greater than demand condition.

In order to detect any common mode errors that may manifest in both the main processor 14 and the quizzer unit 16, the monitor circuit 34, which is separate from the processor 12, is configured to output a disable signal 36 if the monitor circuit does not receive both the quizzer unit signal 30 and the main processor signal 32. Although separating the quizzer unit 16 from the main processor 14 would prevent common mode errors, thereby eliminating the need for the monitor circuit 34, the monitor circuit 34 is a low cost circuit which is less than the cost of having a separate quizzer unit and main processor.

The monitor circuit 34 may additionally be configured to output an override signal 38 to the system 25 to provide additional instructions to the system 25. For example, if the system 25 is an engine, the override signal 38 may reduce the amount of throttle applied and/or adjust the air intake and exhaust systems of the engine.

As a person skilled in the art will readily appreciate, the above description is meant as an illustration of implementation of the principles of this invention. This description is not intended to limit the scope or application of this invention in that the invention is susceptible to modification, variation and change, without departing from the spirit of this invention, as defined in the following claims.

1. An electronic safety monitor system, the system comprising:
a processor having a main processor and a quizzer unit, the main processor being in communication with the quizzer unit;
the main processor having control software and independent plausibility check software, the main processor being configured by the control software to output a control signal corresponding to a driver demand input signal, the main processor being configured by the independent plausibility check software to output an enable signal when the control signal correctly corresponds to the driver demand input signal; and
the quizzer unit being configured to determine if the main processor is correctly executing the control software and the independent plausibility checker software.

2. The system of claim 1, wherein the quizzer unit a coprocessor, an intelligent peripheral or a stacked die.

3. The system of claim 1, further comprising:
the main processor being configured by the independent plausibility check software to output a main processor signal when the control signal correctly corresponds to the driver demand input signal; and
the quizzer unit being configured to output a quizzer unit signal when the main processor is correctly executing the control software and the independent plausibility checker software.

4. The system of claim 3, wherein the main processor signal is one of a toggled signal, an analog signal and a digital signal.

5. The system of claim 3, wherein the quizzer unit signal is one of a toggled signal, an analog signal and a digital signal.

6. The system of claim 3, further comprising:
a monitor circuit in communication with the main processor and quizzer unit; and
the monitor circuit being configured to output an override signal if the monitor does not receive the main processor signal or the quizzer unit signal.

7. The system of claim 1, wherein the main processor is configured by the independent plausibility check software to output the enable signal when the quizzer unit is operating properly.

8. The system of claim 7, wherein the main processor is configured to output the main processor signal when the control signal correctly corresponds to the driver demand input signal and the quizzer unit is operating properly.

9. The system of claim 8, wherein the main processor signal is one of a toggled signal, an analog signal and a digital signal.

10. The system of claim 1, wherein the driver demand signal is a drive-by-wire signal.

11. The system of claim 1, wherein the drive-by-wire signal is one of a throttle-by-wire demand signal, a brake-by-wire demand signal and a steer-by-wire demand signal.
